(19) United States
(12) Patent Application Publication
(10) Pub. No.: US 2003/0051351 A1
(43) Pub. Date: Mar. 20, 2003

(54) Saw chain and guide bar assembly for a chain saw

(76) Inventors: Jochen Buchholtz, Waiblingen (DE); Udo Bartmann, Schwabisch-Gemund (DE)

Correspondence Address: Walter Ottesen, Patent Attorney, P.O. Box 4026, Gaithersburg, MD, 20885-4026, US

(21) Appl. No.: 10/243,726

(22) Filed: Sep. 16, 2002

(30) Foreign Application Priority Data
Sep. 15, 2001 (DE) 101 45 610.7

(51) Int. Cl. B27B 17/02

(52) U.S. Cl. 30/383

(57) ABSTRACT

A cutting assembly (10) of a chain saw (1) includes a saw chain (2) having chain links (3, 4, 5) pivotally connected to each other as well as a guide bar (6) for guiding the saw chain (2) along a peripherally extending edge (7, 8, 9). The cutting assembly (10) includes rubbing pairs (11, 11′, 12, 12′, 13, 13′, 14) forming sliding surfaces (15, 15′, 16, 16′, 17). At least one slide surface (15, 15′, 16, 16′, 17) of a rubbing pair (11, 11′, 12, 12′, 13, 13′, 14) is configured so as to be textured for causing the lubricant film (18) to adhere.

### BACKGROUND OF THE INVENTION

Saw chain and guide bar assemblies for chain saws are subjected to high mechanical loads during operation which causes wear. This occurs especially because of the friction of the individual movable parts against each other.

One such saw chain and guide bar assembly or cutting assembly includes essentially a guide bar having a guide groove formed along the outer longitudinal edge thereof in which the saw chain runs. The saw chain comprises individual chain links and includes individual drive or clearing links having respective rakers which are guided in the groove. The pivotally connected chain links rub against each other in the region of their pivot connections with the movement of the saw chain. Friction forces occur especially in the region of the guide groove between the side walls of the spatially-fixed guide groove and the side surfaces of the moved chain links. Friction also occurs between the spatially-fixed longitudinal edges of the guide bar and the guide surfaces of the individual chain links which slide on these edges.

Many lubricating devices are known for lubricating the existing friction or rubbing pairs wherein lubricating oil is introduced into the guide groove and is there taken up by the drive links and the rakers. Lubricating channels can be provided in the region of the lateral slide surfaces of the chain links for an adequate supply especially of the chain link connections of the individual chain links. A portion of the lubricant is transported to the pivot locations via these lubricant channels. Even for an adequate supply of lubricating oil, a local tear of a lubricant film can occur whereby dry friction or even a short-time adhering friction can occur. The cutting assembly is subjected to early wear.

### SUMMARY OF THE INVENTION

It is an object of the invention to provide a cutting assembly of a chain saw with improved service life in the region of their slide surfaces.

The cutting assembly of the invention is for a chain saw lubricated with a lubricant. The cutting assembly includes: a saw chain including a plurality of links pivotally interconnected; a guide bar having peripherally-extending edge along which the saw chain is guided during operation of the chain saw; the cutting assembly further including slide surfaces defining a plurality of rubbing pairs; and, at least one of the slide surfaces of one of the rubbing pairs being textured to cause a film of the lubricant to adhere thereto.

With respect to the above, at least one slide surface of a friction or rubbing pair of the cutting assembly is configured to be textured. It has been shown that a lubricant film on a textured slide surface adheres more reliably in comparison to a smooth slide surface and does not tend to tear at high sliding velocities. The slide film can be held thin without affecting the lubricating action because of a textured slide surface. In this way, the service life of the cutting assembly can be considerably extended in the region of the slide surfaces. Furthermore, with the improved adherence of the lubricant film at the textured slide surface, a lesser removal of the lubricant results and, as a consequence thereof, only a small resupply of fresh lubricant is required. The operating costs are overall reduced. A supply vessel for the chain lubricant has to be refilled only at longer time intervals.

At least one slide surface of the friction or rubbing pair between the side walls of the guide groove in the guide bar and the corresponding side surfaces of the drive links (that is, the rakers of the drive links) which engage in the guide groove is configured to be textured. In this region, a high sliding velocity as well as a corresponding loading of the friction pair is given by the occurring cutting forces. The wear reduction because of the improved adherence of the lubricant film is especially pronounced in this region. Depending upon the application, it can be practical to configure as textured slide surfaces the following: one or both side surfaces of the rakers, one or both side walls of the guide groove or even side surfaces and side walls in combination. For a texturing of the surfaces of the rakers alone, a corresponding saw chain on an already available non-textured guide bar can be operated as a retrofit with reduced wear. Oppositely, a guide bar having textured side walls of its guide groove can also be operated with a conventional saw chain having improved sliding characteristics. In a combination of two textured slide surfaces of a friction pair, a reduced sensitivity against dirt or damage of one of the slide surfaces is given because the corresponding opposite-lying slide surface can ensure a supportable lubricant film because of its texturing.

It can be practical to configure only selected slide surfaces with texturing especially the high-loaded slide surfaces. In the known configuration of a cutting assembly, each cutting tooth of a cutting link lies with its cutting tip asymmetrically laterally next to a central plane of the guide bar. The cutting force, which acts on the cutting tip, has a component, which lies transversely to the guide bar and this component leads to an increased pressure wear of the rakers in the region of the cutting link on their side surfaces lying opposite the cutting tip. Here, it can be practical to only configure this side surface to have texture. The manufacturing costs are held low and the highly-loaded slide surfaces are reliably protected against wear. It can be practical to configure the sides of the chain links so as to be textured which chain links border one another in the region of the pivotal connection. In this way, in this region too, a reliable support of the lubricant film is ensured. The reduced wear in the region of the pivot connection avoids a deflection of the linkages and therefore an early lengthening of the saw chain whereby a premature exchange thereof is avoided. For a simplified manufacture, the total lateral surface of a cutting link can be configured to have texture, whereby the improved lubricating action is provided in the region of the guide groove as well as in the region of the pivot connections. Here, the texturing can be applied to the side surface in a simple manufacturing step without considering geometric limitations.

Overall, with the textured slide surfaces in accordance with the invention, an improved emergency running characteristic is given. Even for an interruption of the lubricant supply, the supportability of the lubricant film is ensured over a longer time duration. In an incomplete lubricant film, a residual lubricating action is provided because lubricant can collect previously in the deepened regions of the texture.

In an advantageous further embodiment, the respective slide surface is roughened for forming a texturing. The roughness can be generated, for example, as follows: with an etching operation, via mechanical treatments such as sandblasting or the like and especially with the application of a rough coating. A roughness with an unordered distribution of depths and rises can be generated at low manufacturing complexity. Even very fine roughnesses can be generated, for example, by grinding and a reliable adherence even of a very thin lubricant film is made possible. The possibility is provided of further improving the emergency running characteristic with a rough coating including a selection of a suitable coating material such as sintered bronze.

In a practical embodiment, line-shaped recesses, for example, by stamping, rolling, electro-engraving or the like can be introduced into the slide surfaces. In addition to the described improved adherence of the lubricant film, an additional channel effect can be obtained in this way whereby the lubricant is distributed uniformly over the slide surface. The distribution action is further improved with a crossing arrangement of the line-shaped recesses.

A plurality of approximately point-shaped recesses are introduced into the slide surface. The approximately point-shaped recesses exhibit overall a comparatively small surface. The intermediately-lying surfaces, which are raised relative to the recesses, exhibit a correspondingly small surface load. In this way, the lubricant film is overall slightly loaded.

It can also be practical to texture the slide surface in the form of written characters. Beyond the improved lubricating effect, a corresponding textured representation is easy to identify for an operator when changing a saw chain. In a further advantageous variation, the slide surface is textured with an areally configured recess. In the areal recess, a comparatively large quantity of lubricant can collect. Here, the edges around the recess prevent an excessive removal of the lubricant. In this way, and for a reduced lubricant consumption, a comparatively thick lubricant layer can be achieved while avoiding surface contact.

To improve the lubricant supply of even remote regions, one or several lubricant channels are provided in the region of the slide surface through which lubricant is guided. With a lubricant channel of this kind, lubricant is reliably supplied to the slide surface itself as well as also to other lubricating locations such as pivot rivet connections in the chain links. Furthermore, the arrangement of a lubricant reservoir in the region of the slide surface can be practical from which the slide surface can be supplied with lubricant, for example, in an emergency operation over an extended time span.

In a practical embodiment, the slide surface includes an untextured component region. In this way, different friction or rubbing pairs can form for changing operating conditions, changed engine rpms, et cetera. For example, a raker can be laterally textured only in the region of its forward and rearward edges while the intermediate-lying region is smooth. In the low-load state, the untextured region runs by on the side walls of the guide groove. For high lateral loads, a slight tilting leads to a loading of the textured regions. An improved adherence of the lubricant film is automatically given here.

### BRIEF DESCRIPTION OF THE DRAWINGS

The invention will now be described with reference to the drawings wherein:

FIG. 1 is a schematic representation of a chain saw having a mounted cutting assembly;

FIG. 2a is an enlarged cross-sectional representation of a component region of the cutting assembly of FIG. 1;

FIG. 2b is a side elevation view of a segment of a saw chain having textured rakers;

FIG. 2c is a variation of the saw chain segment of FIG. 2b where, alternately, textured and untextured rakers are provided on each side;

FIG. 3 is a schematic detail of the guide bar of FIG. 1 showing the walls of the guide groove with lozenge-shaped texturing;

FIG. 4 is a variation of the arrangement of FIG. 3 wherein the side walls of the groove are provided with ground texturing;

FIG. 5 is a side elevation view of a drive link having a texturing on the raker in the form of horizontal lines;

FIG. 6 is a variation of the drive link with vertically arranged line texturing;

FIG. 7 is a further variation of a drive link having a raker with texturing in the form of combined straight line and arcuately-shaped scores or indentations;

FIG. 8 is a variation of a drive link having a texture in the form of a set of letters;

FIG. 9 is an embodiment of a drive link having texturing in the form of diagonally running lines;

FIG. 10 is a further variation of a drive link having circularly-shaped scores or indentations;

FIG. 11 is a side view of a drive link having crossing-line texturing defining lozenges;

FIG. 12 is an embodiment of a drive link having at least approximately point-shaped indentations in the region of its raker;

FIG. 13 is a variation of a drive link having an areal recess in the raker portion thereof;

FIG. 14 is side view of a drive link having a slide surface which is partially textured and partially untextured;

FIG. 15 shows a drive link having a full surface texturing; and,

FIG. 16 shows a further variation of a drive link having a line-shaped texturing, a lubricant reservoir and a lubricant channel.

### DESCRIPTION OF THE PREFERRED EMBODIMENTS OF THE INVENTION

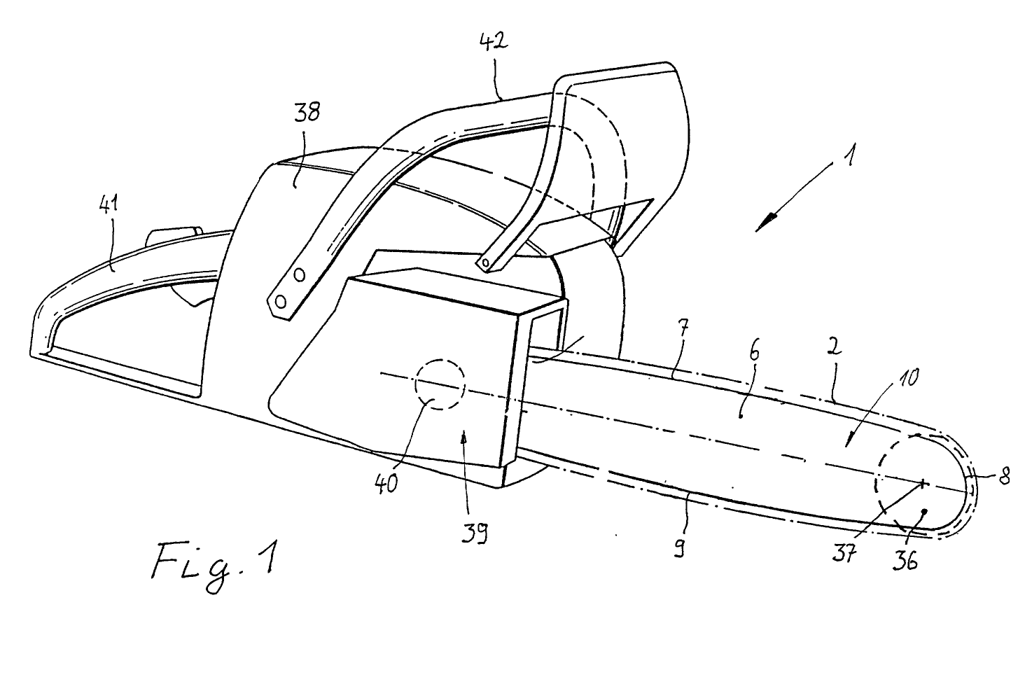

FIG. 1 shows a schematic overview of a chain saw 1 having a housing 38 in which a drive motor is mounted (not shown in greater detail). Two handles (41, 42) are attached to the housing 38 for guiding the chain saw 1. On the end of the housing 38 opposite the rearward handle 41, the chain saw 1 has a cutting assembly 10 which includes a guide bar 6 and a saw chain 2. In the housing 38, a drive sprocket 40 is provided for driving the saw chain 2. The drive sprocket 40 is driven by the drive motor 39. The saw chain 2 runs over the drive sprocket 40 and over upper, end and lower edges (7, 8, 9) of the guide bar 6. An idler sprocket 36 is rotatably journalled about a rotational axis 37 and is provided in the region of the end edge 8 of the guide bar 6. The idler sprocket 36 changes the direction of the saw chain 2 at the end of the guide bar.

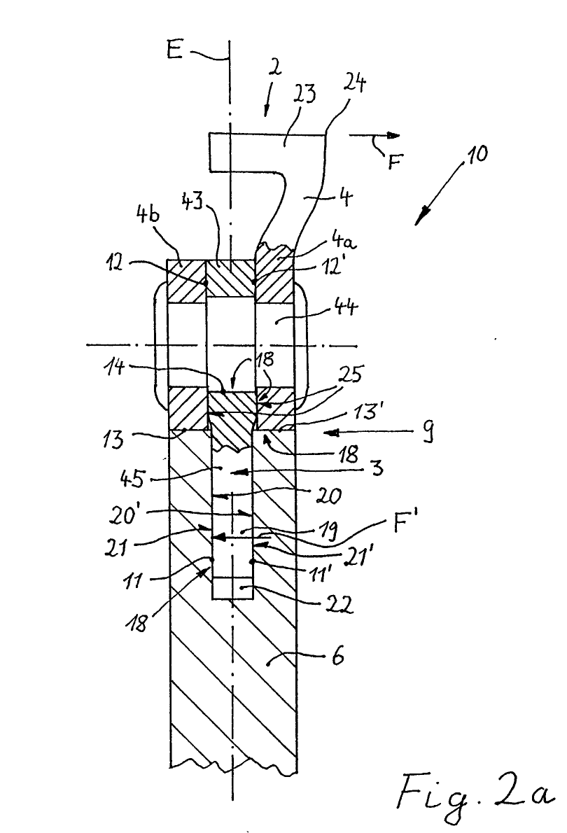

FIG. 2a shows, in an enlarged detail view, a cross section taken through the cutting assembly 10 of FIG. 1 in the region of the lower edge 9 of the guide bar 6 by way of example. In the embodiment shown, the guide bar 6 is configured essentially as one piece and has a guide groove 22 in the region of its peripheral edges (7, 8, 9). The guide bar 6 can also be configured in a sandwich configuration wherein the guide groove 22 is formed by a layered configuration of the guide bar 6.

A drive link 3, which is shown in cross section, includes an upper portion 43 and a lower portion 45. The upper portion 43 lies outside of the guide groove 22 and the lower portion 45 lies within the guide groove 22. The thickness of the lower portion 45 corresponds essentially to the width of the guide groove 22. The drive link 3 can have a constant thickness and, in the embodiment shown, has a greater thickness in the region of the upper portion 43 than the width of the guide groove 22. The lower portion 45 is made by squeezing to the dimension of the width of the guide groove 22.

The drive link is pivotally connected via a rivet 34 to a two-part cutting link 4. The two parts (4a, 4b) of the cutting link 4 lie against both sides on the upper portion 43. The one part 4a of the cutting link 4 includes a cutting tooth 23 having a cutting tip 24. The cutting tip 24 lies laterally displaced referred to a center plane E of the guide bar 6. During cutting, a force acts on the cutting tooth 23 having a component indicated by the arrow F and lying transversely to the center plane E and directed away therefrom. This component force generates a tilt movement of the saw chain 2 about the edges (9 or 7) of the guide bar 6 whereby the lower portion 45 is pressed against a side wall 21 of the guide groove 22 with a force indicated by the arrow F′. Dependent upon the selected cutting geometry, the forces (F, F′) can have a reverse direction as a consequence of which the side surface 20′ is pressed against the side wall 21′.

The lower portion 45 of the drive link 3 is configured as a drive projection or raker 19 for being driven by the drive sprocket 40 (FIG. 1). The raker 19 is described in greater detail hereinafter and satisfies a function as a clearing projection for clearing chips, dirt particles or the like from the guide groove 22.

With the movement of the saw chain 2 about the guide bar 6, the individual parts of the cutting assembly 10 execute sliding or rubbing movements against each other for which a lubricant is conducted into the guide groove 22 for the lubrication of the individual parts. The rakers 19 (that is, the lower parts 45) have side surfaces (20, 20′) which are guided laterally between the side walls (21, 21′) of the guide groove 22, while forming respective rubbing pairs (11, 11′).

Referred to the center plane E, the side surface 20′ lies on the side of the cutter tip 24 and the side surface 20 lies opposite thereto. Additional rubbing pairs (12, 12′) are formed between the side cheeks 25 of the chain links (3, 4, 5) in the region of their pivotal connection. A rubbing pair 14 is formed also between the rivet 44 and the drive link 3. Additional rubbing pairs (13, 13′) are disposed between the peripherally extending edges (7, 8, 9) of the guide bar 6 and the chain links (4, 5) lying in contact engagement therewith. The rubbing pairs (11, 11′, 12, 12′, 13, 13′, 14) are formed as follows: by the side surfaces (20, 20′) in the region of the raker 19, by the side walls (21, 21′) of the guide groove 22 and by the corresponding slide surfaces in the region of the rivet 44 and the peripherally extending edges (7, 8, 9). A lubricant film 18 adheres to the corresponding slide surfaces of the rubbing pairs (11, 11′, 12, 12′, 13, 13′, 14). Depending upon the application, at least one slide surface of a rubbing pair (11, 11′, 12, 12′, 13, 13′, 14) is configured to be textured for holding the lubricating film 18.

FIG. 2b shows, in a side view, a segment of a saw chain 2 wherein a number of drive links 3 is pivotally connected by a rivet 44 alternately to cutting links 4 and connecting links 5. The cutting links 4 are alternatingly arranged so that their respective cutting tips 24 are alternately on both sides of the center plane E (FIG. 2a). Two drive links 3 border on each cutting link 4. In the embodiment shown, and caused by the alternating arrangement of the cutting tips 24, on one side of the saw chain 2, alternatingly, two side surfaces 20, which lie opposite to the cutting tips 24, are followed by side surfaces 20′ lying on the same side of the cutting tips 24. Both side surfaces (20, 20′) of the rakers 19 are configured as textured slide surfaces (15, 15′).

FIG. 2c shows a variation of the saw chain 2 of FIG. 2b according to which on two drive links 3, which border on the cutting link 4, only the slide surfaces 15 are structured, which lie opposite the cutting tip 24 and are subjected to the force F′ (FIG. 2a); whereas, the slide surfaces 15′, which lie at the same side as the cutting tip 24, are untextured. This arrangement is practical for a direction of the forces (F, F′) corresponding to FIG. 2a. For a reversal of the direction of the forces (F, F′) depending upon the selected cutting angle, it can also be practical to configure only the slide surfaces 15′ with texturing, which are subjected to the force F′ and to leave the opposite-lying slide surfaces 15 untextured. In the remaining features and reference numerals, the embodiment of FIG. 2c corresponds to the arrangement of FIG. 2b.

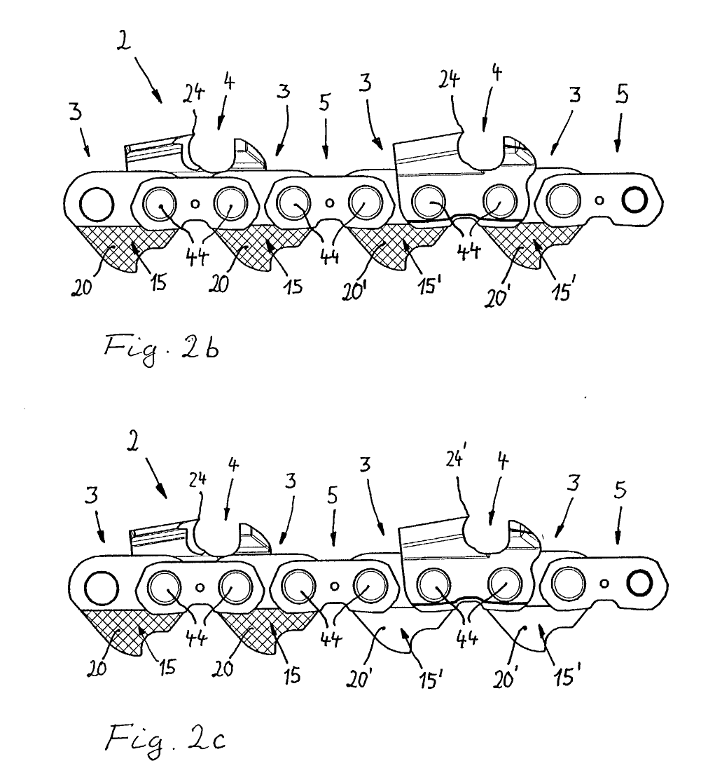

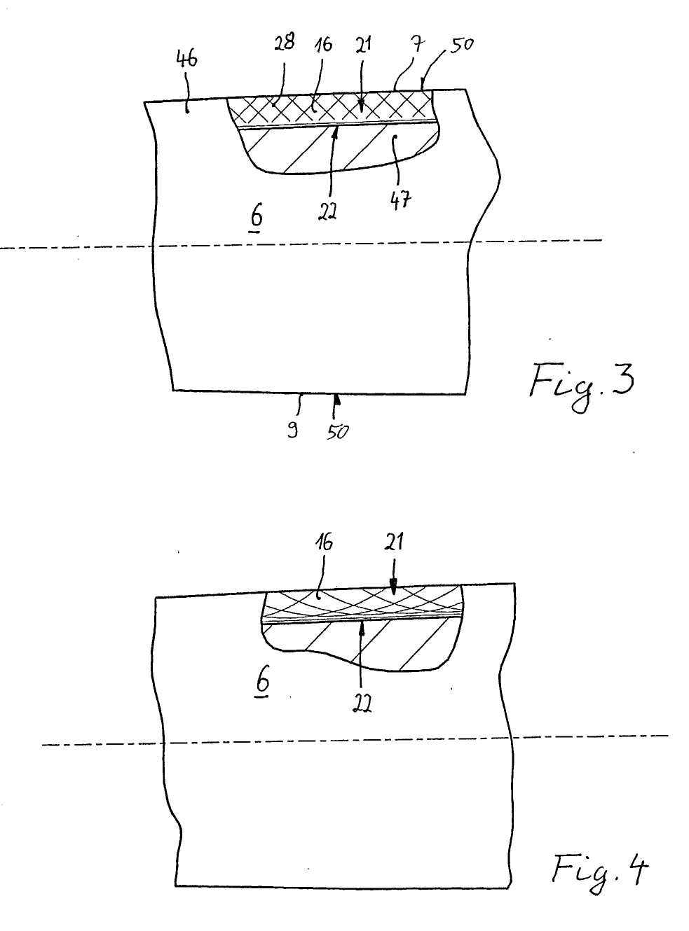

FIG. 3 is a detail view and shows a portion of the guide bar 6 of the chain saw 1 of FIG. 1. The guide bar 6 is built up as a composite bar having two side parts 46 between which a center piece 47 is mounted in a sandwich-like manner. In advance of the assembly of the two side parts 46 and the center piece 47, on the side parts 46, the side walls 21 of the guide groove 22 formed with the assembly are textured with scores or indentations 28. The scores 28 are crossed straight lines arranged to form lozenges. In this way, a textured sliding surface 16 is formed in the guide groove 22. Also, the peripheral edges (7, 8, 9) are configured to be textured for forming a slide surface 50.

A variation of the arrangement of FIG. 3 is shown in FIG. 4 wherein the guide bar 6 is configured as one piece. The side walls 21 of the guide groove 22 are roughened with a grinding body whereby a textured slide surface 16 is formed.

FIG. 5 shows, in a side view, a drive link 3 with its upper portion 43 and its lower portion 45. The lower portion 45 is configured as a raker 19. Rivet holes 48 are provided for passing through a rivet 44 (FIG. 2a). Cheeks 25 in the region of rivet holes 48 form a slide surface 17 of the rubbing pair 12 with a cutting link 4 or a connecting link 5 (FIGS. 2a, 2b, 2c). The upper portion 43 has, together with its slide surfaces 17, a roughened layer 27 applied by plasma beam spraying. The lower portion 45 in the form of raker 19 is on both side surfaces (20, 20′) provided with straight-line scores 20 running horizontally whereby the slide surfaces (15, 15′) are textured. The texture can be generated by rolling, roll-stamping, stamping, electro-engraving, etching, as well as chemical or electrochemically.

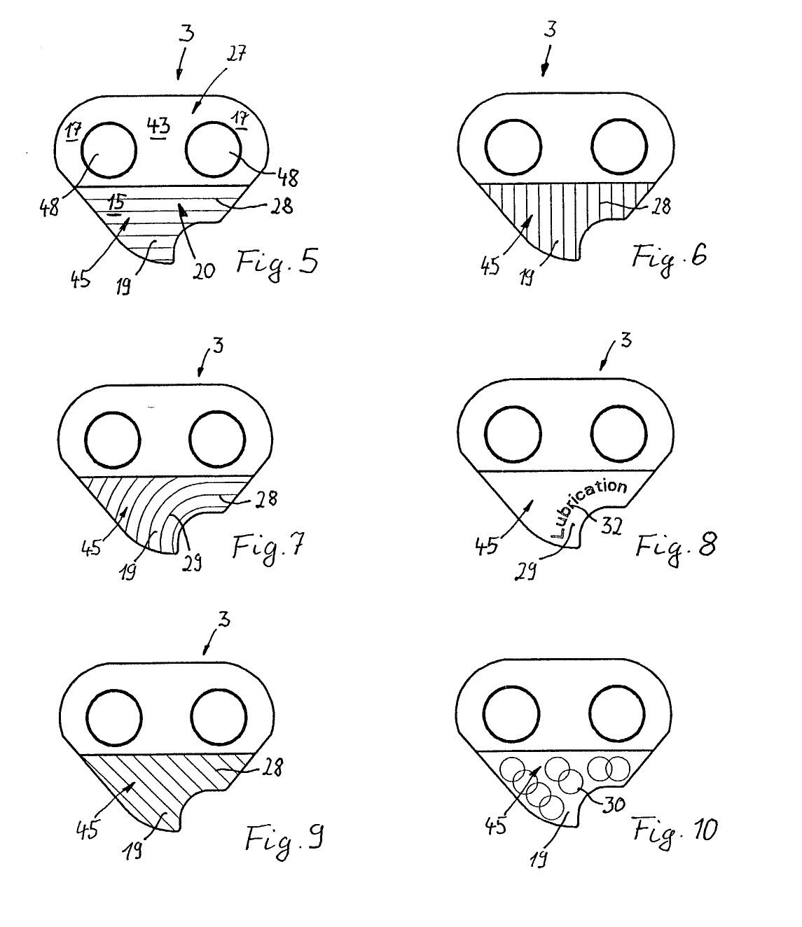

FIG. 6 shows a variation of the drive link 3 of FIG. 5 wherein the linearly-shaped scores or indentations 28 run vertically in the region of the lower portion 45. In the variation of FIG. 7, the lower portion 45 is textured by a combination of straight lines and arcuately-shaped lines (28, 29). A further variation is shown in FIG. 8 wherein the texturing is in the form of a set of letters 32. In the embodiment of FIG. 9, the line-shaped scores or indentations 28 are arranged diagonally referred to the longitudinal direction of the saw chain. FIG. 10 shows a further variation of a drive link 3 having linear-shaped scores or indentations in the form of overlapping circular rings.

The drive link 3 shown in FIG. 11 corresponds to the drive links 3 of FIG. 2b having straight-line scores or indentations 28 arranged in the form of lozenges. In the embodiment of FIG. 12, the slide surfaces (15, 15′) have a texture in the form of approximately point-shaped indentations 31. The slide surfaces (15, 15′) of the drive link 3 of FIG. 13 are textured with an areal recess 33. The areal recess 33 is surrounded by a raised periphery 51.

In the embodiment of FIG. 14, portions of the slide surfaces (15, 15′) are textured by line-shaped scores or indentations 28; whereas, a center region 49 is untextured.

FIG. 15 shows a further variation of a drive link 3 having a constant thickness wherein the total lateral surface 26 is textured in the form of straight-line scores or indentations 28.

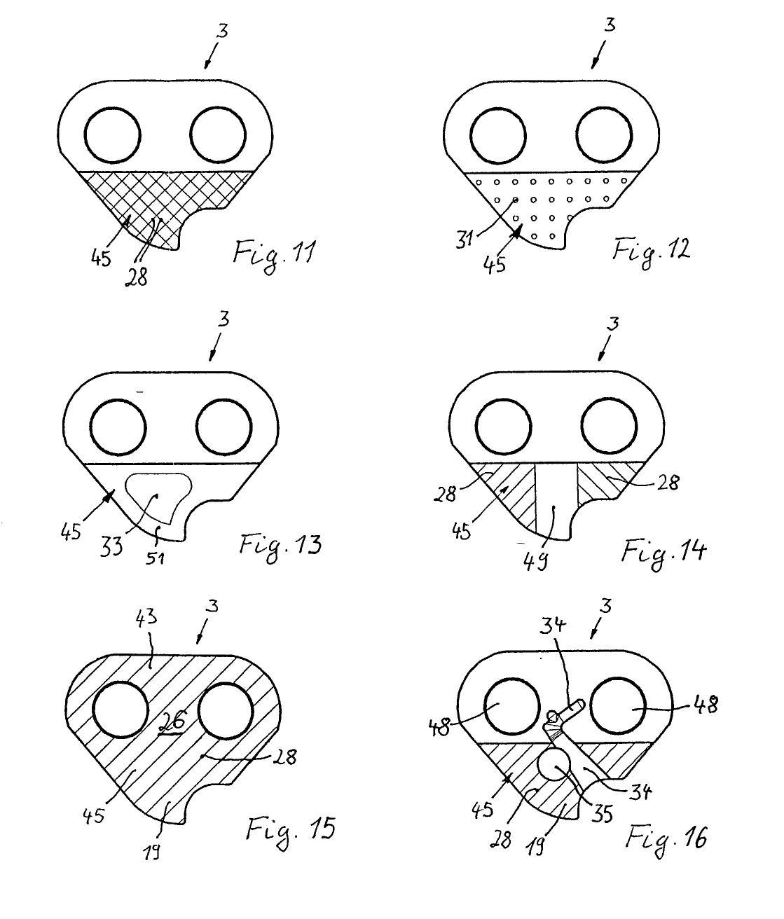

In the embodiment of FIG. 16, a lubricant channel 34 runs through the textured slide surface 15 for supplying the upper portion 43 and the lower portion 45 with fresh lubricant. A circularly-shaped lubricant reservoir 35 is arranged in the boundary region between the textured slide surface 15 and the lubricant channel 34.

The embodiments of FIGS. 5 to 16 show, by way of example, different embodiments of textured slide surfaces 15. Depending upon the application, and in lieu thereof, also individual ones of the remaining slide surfaces (15, 15′, 16, 16′, 17) or any desired combination thereof can be textured for forming rubbing pairs (11, 12, 13, 14) of a cutting assembly 10 (FIG. 2a).

It is understood that the foregoing description is that of the preferred embodiments of the invention and that various changes and modifications may be made thereto without departing from the spirit and scope of the invention as defined in the appended claims.

What is claimed is:

1. A cutting assembly for a chain saw lubricated with a lubricant, the cutting assembly comprising:
a saw chain including a plurality of links pivotally interconnected;
a guide bar having peripherally-extending edge along which said saw chain is guided during operation of the chain saw;
said cutting assembly further including slide surfaces defining a plurality of rubbing pairs; and,
at least one of the slide surfaces of one of said rubbing pairs being textured to cause a film of said lubricant to adhere thereto.

2. The cutting assembly of claim 1,
said guide bar having a guide groove formed in said peripherally-extending edge and said guide groove having mutually adjacent side walls having respective side wall surfaces;
a first portion of said links being drive links having respective rakers extending into said guide groove for being guided therein as said saw chain moves over and along said guide bar during operation of the chain saw;
each of said rakers having side surfaces which coact with corresponding ones of said side wall surfaces to form a plurality of rubbing pairs; and,
at least one of said side surfaces of said rakers and said side wall surfaces being textured.

3. The cutting assembly of claim 2, wherein at least one of the side surfaces of each of said rakers is textured.

4. The cutting assembly of claim 3, wherein said guide bar defines a center plane (E); a second portion of said links are cutting links having respective cutting teeth and each of said cutting teeth has a cutting tip disposed laterally of said center plane (E); each two of said drive links are connected to a corresponding one of said cutting links; and, the side surfaces of said two drive links lying opposite said cutting tip referred to said center plane (E) are textured slide surfaces.

5. The cutting assembly of claim 4, wherein said side wall surfaces are textured slide surfaces.

6. The cutting assembly of claim 1, wherein said links are connected at a plurality of pivot connections; said links lie one against the other at the region of said pivot connections; said links define respective cheeks at the region of said pivot connections and each two of said cheeks are in mutual contact engagement at a corresponding one of said pivot connections to define sliding surfaces of a rubbing pair; and, at least one of the sliding surfaces of each fo these pairs is textured.

7. The cutting assembly of claim 2, wherein the entire side surface of each of said drive links is textured.

8. The cutting assembly of claim 1, wherein said slide surfaces are textured by roughening.

9. The cutting assembly of claim 8, wherein a rough coating is applied to the region of slide surfaces.

10. The cutting assembly of claim 1, wherein line-shaped indentations or scores are formed is said slide surfaces.

11. The cutting assembly of claim 10, wherein said line-shaped indentations or scores mutually cross.

12. The cutting assembly of claim 1, wherein point-shaped indentations are introduced into said slide surfaces.

13. The cutting assembly of claim 1, wherein said slide surfaces are textured in the form of a set of letters.

14. The cutting assembly of claim 1, wherein said slide surfaces are each structured to have an areal recess.

15. The cutting assembly of claim 1, wherein a lubricating channel is provided in the region of each of said slide surfaces.

16. The cutting assembly of claim 1, wherein a lubricant reservoir is provided in the region of each of said slide surfaces.

17. The cutting assembly of claim 1, wherein each of said slide surfaces has a region which is not textured.

18. A guide bar for a saw chain comprising:
an elongated bar having a peripherally-extending edge;
said elongated bar having a guide groove formed in said edge for guiding the saw chain;
said guide bar having slide surfaces for said saw chain; and,
at least one of said slide surfaces being textured to cause a lubricant film to adhere thereto.

19. The guide bar of claim 18, wherein said groove defines two mutually adjacent side walls; and, said one of said slide surfaces is defined by one of said side walls.

20. A saw chain of a chain saw comprising:
a saw chain including a plurality of links pivotally interconnected;
said links including slide surfaces; and,
at least one of said slide surfaces is textured to cause a lubricant film to adhere thereto.

21. The saw chain of claim 21, wherein: said chain saw has an elongated bar having a peripherally-extending edge; said elongated bar having a guide groove formed in said edge for guiding the saw chain; said guide groove is defined by mutually adjacent side wall surfaces; and, wherein:
a first portion of said links being drive links having respective rakers extending into said guide groove for being guided therein as said saw chain moves over and along said guide bar during operation of the chain saw;
each of said rakers having side surfaces which coact with corresponding ones of said side wall surfaces to form a plurality of rubbing pairs; and,
at least one of said side surfaces of said rakers is textured.
